(19) United States
(12) Patent Application Publication
(10) Pub. No.: US 2022/0314933 A1
(43) Pub. Date: Oct. 6, 2022

(54) METHOD FOR DETERMINING A MOTION STATE OF A PORTABLE TRANSCEIVER DEVICE, METHOD FOR REMOTELY UNLOCKING A DOOR AND PORTABLE TRANSCEIVER DEVICE FOR UNLOCKING A DOOR

(71) Applicant: BCS AUTOMOTIVE INTERFACE SOLUTIONS US LLC, Wilmington, DE (US)

(72) Inventor: Karthik BALAKRISHNA, Novi, MI (US)

(21) Appl. No.: 17/223,552

(22) Filed: Apr. 6, 2021

(51) Int. Cl. B60R 25/24; B60R 25/34; B60R 25/01

(52) U.S. Cl. CPC B60R 25/245; B60R 25/34; B60R 25/01

(57) ABSTRACT

In a method for determining a motion state of a portable transceiver device for unlocking a door, especially a vehicle door, a radio signal is received at the portable transceiver device. Moreover, a signal strength of the received radio signal is determined. Furthermore, a signal strength variation is determined by comparing the determined signal strength to a previously determined signal strength or by comparing the determined signal strength to a predefined signal strength. Subsequently, it is established that the portable transceiver device is in motion if the amount of signal strength variation exceeds a preset threshold. Alternatively, it is established that the portable transceiver device is at rest if the amount of signal strength variation is equal or lower than the preset threshold. Moreover, a method for remotely unlocking a door, especially a vehicle door, is presented. Also, a portable transceiver device for unlocking a door, especially a vehicle door, is described.

### FIELD OF THE INVENTION

The invention is directed to a method for determining a motion state of a portable transceiver device for unlocking a door, especially a vehicle door. Moreover, the invention relates to a method for remotely unlocking a door, especially a vehicle door. The invention is additionally directed to a portable transceiver device for unlocking a door, especially a vehicle door, comprising a transceiver unit and a controller unit.

### BACKGROUND

Methods as described above and portable transceiver devices as described above are known in the art.

In the context of vehicles, the portable transceiver device can also be called a key fob or just a fob.

Such portable transceiver devices are usually listening out for signals broadcast from a corresponding vehicle. The portable transceiver device can then answer by sending a signal to the vehicle. Such an answer signal is necessary for starting an unlocking activity of the vehicle. However, the portable transceiver device needs to be in the proximity of the vehicle so that the vehicle's antenna can detect the signal and start the unlocking activity, i.e. the vehicle can only be unlocked if the portable transceiver device is in the proximity of the vehicle.

Such systems can be manipulated by so-called relay attacks.

In such an attack an attacker uses a radio amplification equipment to boost the signal sent from the portable transceiver device which is actually out of range of the vehicle, e.g. inside the owner's home. The amplified signal is transmitted to a device placed near the vehicle such that the vehicle is able to receive the unlocking signal without the portable transceiver device being in its proximity.

Such attacks need to be avoided. In order to do so, it is known to provide the portable transceiver device with a motion sensor and prevent the portable transceiver device from sending any signal if it is at rest. Thus, it is not possible to unlock the vehicle while the transceiver device is not in motion.

### SUMMARY OF THE INVENTION

It is an object of the present invention to further improve known methods for determining a motion state of a portable transceiver device. Moreover, known methods for remotely unlocking a door shall also be improved. The same is true for portable transceiver devices for unlocking a door. Both the methods and the portable transceiver device shall be simplified in a structural sense. Moreover, corresponding costs shall be reduced.

The present invention provides a method for determining a motion state of a portable transceiver device for unlocking a door, especially a vehicle door, comprising the steps of:
a) receiving a radio signal at the portable transceiver device,
b) determining a signal strength of the received radio signal,
c) determining a signal strength variation by comparing the determined signal strength to a previously determined signal strength or by comparing the determined signal strength to a predefined signal strength,
d) establishing that the portable transceiver device is in motion if the amount of signal strength variation exceeds a preset threshold or establishing that the portable transceiver device is at rest if the amount of signal strength variation is equal or lower than the preset threshold.

In this context, a signal strength can be represented by a so-called RSSI (Received Signal Strength Indication) value. Thus, by using such a method, a motion state of a portable transceiver device can be determined in a structurally simple and reliable manner. As compared to the prior art, a dedicated motion sensor is not necessary. Consequently, the method can be performed in a very cost-efficient way.

It is noted that the detection of a motion state is different from the detection of a position or localization of the portable transceiver device. In other words, a motion state defines whether the portable transceiver device is moving or not. A position or a localization defines a spot within a space, where the portable transceiver device is arranged. In the present invention, the signal strength variation is only determined in order to define a motion state and not for localization purposes.

The signal strength variation may only be determined if the determined signal strength of the received radio signal is above a predefined threshold. In other words, if the determined signal strength of the received radio signal is below the predefined threshold or corresponds to the threshold, the signal strength variation is not determined and the remaining steps of the method are not performed. It is assumed that in such a case the portable transceiver device is too far away from an entity sending the radio signal to be received at the portable transceiver device. Moreover, it is guaranteed that the portable transceiver device does not react to noise. Consequently, the portable transceiver device can be operated in an energy efficient manner. Especially, battery life can be extended.

The invention further provides a method for remotely unlocking a door, especially a vehicle door, comprising the steps of:
a) emitting a radio signal from the door or an object comprising the door, the radio signal being a request signal,
b) receiving the request signal at a portable transceiver device,
c) determining a signal strength of the received request signal,
d) determining a signal strength variation by comparing the determined signal strength to a previously determined signal strength or by comparing the determined signal strength to a predefined signal strength,
e) emitting a radio signal from the portable transceiver device as an answer signal only if the amount of signal strength variation exceeds a preset threshold.
f) receiving the answer signal at the door or at the object comprising the door and performing an unlocking activity.

In this context, a door is to be understood in the large sense. Thus, any lockable closure device may be designated a door. Especially a gate, a flap or a hatch is to be considered a door in the present context. This method is structurally simple and can be performed at comparatively low costs. This is especially due to the fact that no dedicated sensors are necessary. Also in the context of the present method a signal strength can be represented by a so-called RSSI (Received Signal Strength Indication) value.

In the above method for remotely unlocking a door, step e) implicitly determines a motion state of the portable transceiver device. Thus, in step e) it is established that the portable transceiver device is in motion if the amount of signal strength variation exceeds a preset threshold or it is established that the portable transceiver device is at rest if the amount of signal strength variation is equal or lower than the preset threshold. Consequently, a radio signal is only emitted from the portable transceiver device as an answer signal if the portable transceiver device is in motion. Only then the unlocking activity is possible.

In other words, the method for determining a motion state of a portable transceiver device can be integrated into the method for remotely unlocking a door.

Then the method for remotely unlocking a door, especially a vehicle door, comprises the steps of:
a) emitting a radio signal from the door or an object comprising the door, the radio signal being a request signal,
b) receiving the request signal at a portable transceiver device,
c) determining a signal strength of the received request signal,
d) determining a signal strength variation by comparing the determined signal strength to a previously determined signal strength or by comparing the determined signal strength to a predefined signal strength,
e) emitting a radio signal from the portable transceiver device as an answer signal only if the portable transceiver device is in motion, wherein it is established that the portable transceiver device is in motion if the amount of signal strength variation exceeds a preset threshold and wherein it is established that the portable transceiver device is at rest if the amount of signal strength variation is equal or lower than the preset threshold,
f) receiving the answer signal at the door or at the object comprising the door and performing an unlocking activity.

Also in the method for remotely unlocking a door, the signal strength variation may only be determined if the determined signal strength of the received request signal is above a predefined threshold. The same effects and advantages that have already been explained in connection with the method for determining a motion state of a portable transceiver device result from this configuration.

Moreover, the answer signal may only be emitted if the determined signal strength is bigger than the previously determined signal strength or the predefined signal strength. This means that the answer signal is only emitted if the signal strength is increasing. This may be interpreted in that the answer signal is only emitted if the portable transceiver device is approaching the door or the object comprising the door. This is usually the case if an authorized user intends to unlock the door. Thus, the security of the method is further enhanced without impairing the standard use case.

The request signal may be emitted periodically, especially every 0.2 to 0.7 seconds. In an example, the request signal is emitted every 0.5 seconds. Such a signal may be called a polling signal. Consequently, the method according to the invention may be initiated with the same periodicity. Thus, from the perspective of a user, the method may be performed in a very reactive manner. It is noted that the remaining method steps are performed under the condition that the request signal is received at the portable transceiver device. Otherwise, the method is abandoned.

Also, the door may be a vehicle door and the request signal may only be emitted if an engine of the vehicle is off. In other words, the request signal is only emitted if the engine of the vehicle is not running. It is supposed that the door does not need to be unlocked in a condition in which the engine is running. Thus, the method is only performed in an operational condition of the vehicle in which unlocking of the door is potentially desired. Consequently, the method can be performed in an energy efficient manner. Furthermore, operational safety is enhanced by only allowing the method to be performed in an appropriate condition of the vehicle.

It is additionally possible that the request signal is only emitted if the door is closed and locked. The closed and locked condition of the door may be detected by a corresponding sensor. Additionally or alternatively, an information provided by a control unit and designating the closed and locked state of the door may be used. Thus, also in this respect the method is only performed if the door is in an appropriate condition. Consequently, the method can be performed in a safe and energy efficient manner.

Furthermore, an identification value in the received answer signal may be checked and the unlocking activity may only be performed if the identification value is an authorized identification value. In doing so, it is guaranteed that only an authorized portable transceiver device may unlock the door.

Moreover, the signal may only be emitted if the portable transceiver device is detected to be in an outside region of the door. Generally speaking, a door is used for selectively separating two regions. One of these regions may be designated an inside region and one of these regions may be designated an outside region. In the context of the present invention, the inside region may be rendered accessible by unlocking the door. If the door is locked, the inside region is not accessible from the outside region. Thus, unlocking of the door may potentially be desired if the portable transceiver device is in the outside region. If the portable transceiver device is in the inside region, either a user thereof is also in the inside region or the user is in the outside region while the portable transceiver device is in the inside region. In both alternatives locking and unlocking of the door is not useful. Thus, performing the method only if the portable transceiver device is detected to be in an outside region of the door leads to a high level of operational safety and efficiency.

The invention further provides a portable transceiver device for unlocking a door, especially a vehicle door, comprising a transceiver unit and a controller unit, wherein the transceiver unit and the controller unit are adapted for performing a method according to the invention. This means that the controller unit and the transceiver unit are adapted for performing a method for determining a motion state of a portable transceiver device and/or for performing a method for remotely unlocking a door. Beyond that, the effects and advantages which have been explained in connection with the methods according to the invention also apply to the portable transceiver device according to the invention and vice versa.

### BRIEF DESCRIPTION OF THE DRAWINGS

FIG. 1 schematically shows a vehicle and a portable transceiver device according to the invention, wherein the vehicle and the portable transceiver device can be used for performing a method for determining a motion state of the portable transceiver device according to the invention and for performing a method for remotely unlocking a door according to the invention,

FIG. 2 shows detailed steps of the method for determining a motion state of the portable transceiver device, and

FIG. 3 shows detailed steps of the method for remotely unlocking the door.

### DETAILED DESCRIPTION

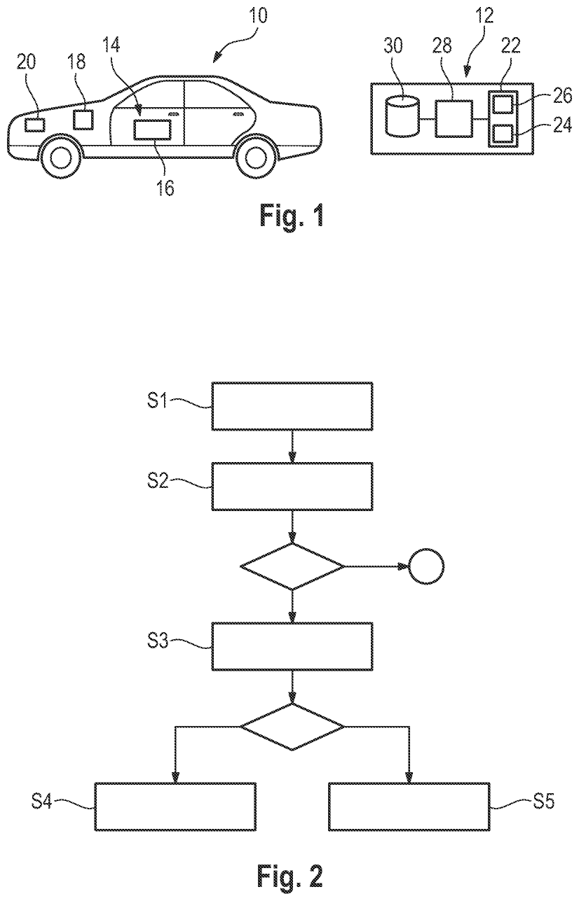

FIG. 1 shows a vehicle 10 and a portable transceiver device 12.

The portable transceiver device 12 is a key fob for unlocking a door 14 of the vehicle. In the following explanations, a driver door 14 of the vehicle 10 will be used as an illustrative example. However, it is understood that the explanations also apply to any other door of the vehicle 10.

The vehicle 10 comprises a first antenna device 16 which is arranged inside the door 14.

The first antenna device 16 is configured for emitting a radio signal which is a low frequency (LF) signal in the present example.

Moreover, the vehicle 10 comprises a second antenna device 18 which configured for receiving a radio signal sent from the portable transceiver device 12.

The second antenna device 18 is configured for receiving a high frequency (HF) signal, i.e. the first antenna device 16 and the second antenna device 18 operate on different frequency bands.

The vehicle 10 further comprises a control unit 20 configured for controlling the first antenna device 16 and the second antenna device 18. Additionally, the control unit 20 is configured for sending a signal for unlocking to the door 14.

The portable transceiver device 12 comprises a transceiver unit 22.

The transceiver unit 22 has a third antenna device 24 which is adapted for receiving the radio signal sent by the first antenna device 16. Consequently, the third antenna device 24 is adapted for receiving LF signals.

The transceiver unit 22 additionally comprises a fourth antenna device 26 which is configured for sending a radio signal which is a HF signal. Thus, this signal can be received by the second antenna device 18 if the portable transceiver device 12 is in the vicinity of the vehicle 10.

Moreover, a controller unit 28 and a storage unit 30 are provided.

The storage unit 30 is adapted for storing information relevant for the operation of the portable transceiver device 12. The controller unit 28 is configured for controlling both the storage unit 30 and the transceiver unit 22.

The controller unit 28 and the transceiver unit 22 are adapted for performing a method for determining a motion state of the portable transceiver device 12 (cf. FIG. 2). This means that it can be determined if the portable transceiver device 12 is in motion or at rest.

To this end, in a first step S1, a radio signal is received at the portable transceiver device 12. In the example shown, this radio signal is emitted by the first antenna device 16 of the vehicle 10.

Thereafter, in a step S2, a signal strength of the received radio signal is determined.

If the signal strength is found to be equal or below a predefined threshold, the received radio signal is considered to be noise and the method is abandoned.

The threshold is stored on the storage unit 30.

However, if the determined signal strength of the received radio signal is above the predefined threshold, the method is continued.

In this case, a signal strength variation is determined in a step S3.

This is done by comparing the determined signal strength to a previously determined signal strength or by comparing the determined signal strength to a predefined signal strength.

The previously determined signal strength and the predefined signal strength can be stored on the storage unit 30 such that they are easily accessible for performing step S3.

On the basis of the signal strength variation it is established that the portable transceiver device 12 is in motion if the amount of signal strength variation exceeds a preset threshold (cf. step S4).

Alternatively, if the amount of signal strength variation is equal or lower than the preset threshold, it is established that the portable transceiver device 12 is at rest (cf. step S5).

Also the preset threshold for the signal strength variation can be stored on the storage unit 30.

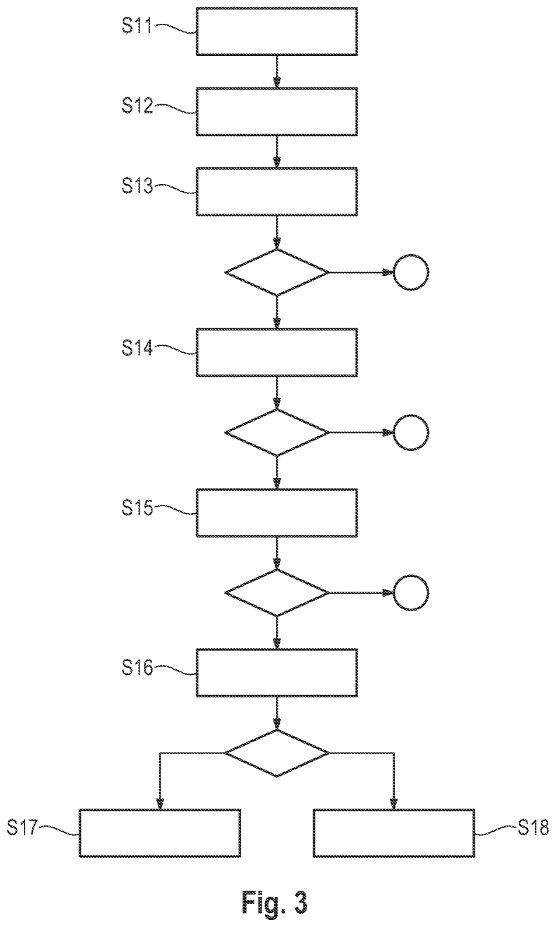

The controller unit 28 and the transceiver unit 22 are also adapted for performing a method for remotely unlocking the door 14 of the vehicle 10 (cf. FIG. 3).

To this end, in a first step S11, a radio signal is emitted from the door 14, more precisely from the first antenna device 16.

This radio signal is a request signal, which is emitted periodically, in the present example every 0.5 seconds.

In the present example, the request signal is only sent if an engine of the vehicle 10 is off and the door 14 is closed and locked. Otherwise, the method is abandoned.

A further condition for emitting the request signal is that the portable transceiver device 12 is detected to be in an outside region of the door 14, i.e. the request signal is only emitted if the portable transceiver device 12 is not inside the vehicle 10.

In a subsequent step S12, the request signal is received at the portable transceiver device 12, more precisely at the third antenna device 24.

Thereafter, in a third step S13, a signal strength of the received request signal is determined.

If the determined signal strength is equal or below a predefined threshold, the method is abandoned.

Otherwise, i.e. if the determined signal strength of the received request signal is above the predefined threshold, the method is continued.

In this context, the predefined threshold can be stored on the storage unit 30.

Subsequently, in a step S14, a signal strength variation is determined by comparing the determined signal strength to a previously determined signal strength or by comparing the determined signal strength to a predefined signal strength.

Again, the previously determined signal strength and the predefined signal strength can be stored on the storage unit 30.

Furthermore, a check is performed for establishing whether the determined signal strength is bigger than the previously determined signal strength or the predefined signal strength. In this case, the method is continued since the fact that the determined signal strength is increased with respect to the previously determined signal strength or the predefined signal strength is interpreted as an approaching motion of the portable transceiver device 12 towards the vehicle 10.

Otherwise, i.e. if the determined signal strength is equal or smaller than the previously determined signal strength or the predefined signal strength, the method is abandoned.

Moreover, in a step S15, a radio signal is emitted from the portable transceiver device 12 as an answer signal, if the amount of signal strength variation exceeds a preset threshold.

As before, the preset threshold is stored on the storage unit 30.

Since the portable transceiver device 12 carries an identification, an identification value is comprised by the answer signal.

In an additional step S16, the answer signal is received at the door 14 of the vehicle and the identification value is checked, i.e. it is determined if the identification value is an authorized identification value. In other words, it is determined if the portable transceiver device 12 is authorized for unlocking the door 14.

In the positive case, an unlocking activity is performed by the control unit 20, i.e. at least an unlocking signal is sent to the door 14 in a step S17.

If the identification value is not an authorized identification value, no unlocking activity is performed (cf. step S18).

1. (canceled)

2. (canceled)

3. A method for remotely unlocking a door, comprising:
a) emitting a radio signal from the door or an object including the door, the radio signal being a request signal,
b) receiving the request signal at a portable transceiver device,
c) determining a signal strength of the received request signal,
d) determining a signal strength variation by comparing the determined signal strength to a previously determined signal strength or by comparing the determined signal strength to a predefined signal strength,
e) emitting a radio signal from the portable transceiver device as an answer signal only if the amount of signal strength variation exceeds a preset threshold, and
f) receiving the answer signal at the door or at the object including the door and performing an unlocking activity.

4. The method according to claim 3, wherein the signal strength variation is only determined if the determined signal strength of the received request signal is above a predefined threshold.

5. The method according to claim 3, wherein the answer signal is only emitted if the determined signal strength is bigger than the previously determined signal strength or the predefined signal strength.

6. The method according to claim 3, wherein the request signal is emitted periodically.

7. The method according to claim 3, wherein the door is a vehicle door and the request signal is only emitted if an engine of the vehicle is off.

8. The method according to claim 3, wherein the request signal is only emitted if the door is closed and locked.

9. The method according to claim 3, wherein an identification value in the received answer signal is checked and the unlocking activity only is performed if the identification value is an authorized identification value.

10. The method according to claim 3, wherein the request signal is only emitted if the portable transceiver device is detected to be in an outside region of the door.

11. A portable transceiver device for unlocking a door, comprising a transceiver unit and a controller unit, wherein the transceiver unit and the controller unit are adapted for performing a method according to claim 3.

12. The method according to claim 6, wherein the request signal is emitted every 0.2 to 0.7 seconds.
